(19) United States
(12) Patent Application Publication
(10) Pub. No.: US 2020/0207644 A1
(43) Pub. Date: Jul. 2, 2020

(54) METHOD FOR REMOVING SILICA IN SALT WATER

(71) Applicant: KURITA WATER INDUSTRIES LTD., Tokyo (JP)

(72) Inventors: Satoshi MIWA, Tokyo (JP); Ryouichi YAMADA, Tokyo (JP)

(21) Appl. No.: 16/475,550

(22) PCT Filed: Sep. 12, 2017
(86) PCT No.: PCT/JP2017/032798

§ 371 Date: Jul. 2, 2019

(30) Foreign Application Priority Data
Feb. 24, 2017 (JP) 2017-033457

(51) Int. Cl. C02F 1/42; C02F 1/66; C02F 1/28; C25B 1/46

(52) U.S. Cl. CPC C02F 1/42; C02F 1/66; C02F 2103/08; C25B 1/46; C02F 2001/422; C02F 1/281

(57) ABSTRACT

A method for removing silica in salt water, including adjusting salt water containing silica ions to a pH of 9 or more, and then bringing the salt water into contact with a selective adsorbent for silica ions. Preferably, the salt water is passed through an adsorption tower filled with the adsorbent at an LV of 0.5 to 20 m/h. The adsorbent is a metal hydroxide adsorbent or a strongly basic anion exchanger having a glucamine group.

### TECHNICAL FIELD

The present invention relates to a method for removing a silica component dissolved in salt water. The present invention relates to a method for selectively removing silica ions without removing salt in salt water. The present invention also relates to a method for producing caustic soda and chlorine using this method.

### BACKGROUND ART

Ion exchange membrane electrolysis is used in an application of electrolyzing salt water to produce caustic soda and chlorine. For example, when an electrolytic cell is divided into an anode chamber and a cathode chamber by a cation exchange membrane, salt water is flowed into the anode chamber, water is flowed into the cathode chamber, and a direct current is flowed between both electrodes, sodium ions, which are cations, move into the cathode chamber via the cation exchange membrane, chlorine ions, which are anions, remain in the anode chamber, chlorine gas is generated in the anode chamber, and caustic soda is generated in the cathode chamber.

When an electrolytic cell is divided into an anode chamber and a cathode chamber by an anion exchange membrane, salt water is flowed into the cathode chamber, water is flowed into the anode chamber, and a direct current is flowed between both electrodes, chlorine ions, which are anions, move into the anode chamber via the anion exchange membrane, sodium ions, which are cations, remain in the cathode chamber, chlorine gas is generated in the anode chamber, and caustic soda is generated in the cathode chamber.

Caustic soda is one of the basic chemicals that are industrially very important. For example, caustic soda is used in applications as a neutralizing agent for water supply and sewerage systems, and industrial wastewater as an alkali, and applications for extracting alumina (aluminum oxide), which is a raw material of aluminum, from bauxite.

Chlorine is widely used as a raw material of various chlorides such as hydrochloric acid and chloroform, and as a raw material of synthetic resins such as polyvinyl chloride and polyvinylidene chloride. Chlorine is also used as a synthetic intermediate in the production of products that do not contain chlorine, such as silicones, polyurethanes, and various polymers.

In ion exchange membrane electrolysis, when using seawater or a solution in which natural salts such as rock salt is dissolved as the salt water to be electrolyzed, coexisting components such as calcium, magnesium, and silica are oxidized by electrification or react with a sulfur component, forming insoluble compounds such as gypsum and silicon dioxide, for example, on the electrode or in the ion exchange membrane, thereby causing problems such as increasing the electric resistance, reducing the electrolytic efficiency by inhibiting ion transfer, or reducing the durability of the electrode or ion exchange membrane. As a method for removing these undesirable coexisting components in advance, for example, there has been proposed an ion exchange adsorption method using an ion exchange resin, a separation method using a reverse osmosis membrane, and the like.

In the ion exchange adsorption method using an ion exchange resin, for example, salt water is brought into contact with a cation exchange resin formed from particles of a polymer having a sulfonic acid group (—SO₃H) or a carboxyl group (—COOH) as a cation exchange group to exchange and adsorb the cations in the salt water with the hydrogens of the cation exchange group of the cation exchange resin. The cation exchange resin exchanges and adsorbs cations such as calcium ions, magnesium ions, and sodium ions in the salt water, but cannot adsorb anionic silica ions.

An anion exchange resin formed from particles of a polymer having an amino group (—H₃) or a quaternary ammonium group (—NR₄⁺) as an anion exchange group adsorbs chlorine ions (Cl⁻) in salt water. However, such an anion exchange resin has low adsorptivity of weakly acidic silica, and cannot adsorb silica ions when coexisting with other cations or anions.

Examples of the separation method using a reverse osmosis membrane include high-pressure reverse osmosis membrane separation for producing desalinated water from seawater, low-pressure reverse osmosis membrane separation for producing pure water and the like by removing small molecule organic matter and trace ionic components from tap water. In desalination using a reverse osmosis membrane, ions such as chlorine ions, sodium ions, and silica ions in the salt water are removed at a constant removal rate, and it is not possible to remove only the silica ions and keep the salt in the salt water.

Thus, until now, a method for removing a soluble silica component without removing the salt in the salt water has not been proposed.

It is known to produce salt by removing bromide ions from concentrated salt water with a strongly basic anion exchange resin (PTL 1), and similarly to remove boron from seawater using a boron selective resin (PTL 2). However, neither PTL 1 nor PTL 2 mentions removal of silica ions.
PTL 1: JPH 11-196814 A
PTL 2: JP 2003-326257 A

### SUMMARY OF INVENTION

It is an object of the present invention to provide a method for selectively removing silica ions without removing salt in salt water, and a method for producing caustic soda and chlorine utilizing this method.

The present inventors have found that by bringing salt water adjusted to a predetermined pH into contact with a selective adsorbent for silica ions having a functional group or a compound having high reactivity with weakly acidic silica ions while having no reactivity with salt and not reacting with the chlorine ions or sodium ions in salt water, silica ions can be selectively adsorbed and removed without adsorbing the salt in the salt water.

Specifically, the present invention provides the following.
[1] A method for removing silica in salt water, comprising adjusting salt water containing silica ions to a pH of 9 or more, and then bringing the salt water into contact with a selective adsorbent for silica ions.
[2] The method for removing silica in salt water according to [1], wherein the selective adsorbent for silica ions is a metal hydroxide adsorbent or a strongly basic anion exchanger having a glucamine group.
[3] The method for removing silica in salt water according to [1] or [2], wherein the salt water containing silica ions is passed through an adsorption tower filled with the selective adsorbent for silica ions.
[4] The method for removing silica in salt water according to any one of [1] to [3], wherein the salt water containing silica ions is passed through the adsorption tower at a linear flow rate (LV) of 0.5 to 20 m/h.
[5] A method for producing caustic soda and chlorine, comprising removing silica ion in salt water by the method for removing silica in salt water according to any one of [1] to [4], and then producing caustic soda and chlorine by ion exchange membrane electrolysis.

### ADVANTAGEOUS EFFECTS OF INVENTION

According to the present invention, silica ions can be selectively removed without removing the salt in the salt water. Therefore, by supplying salt water from which silica ions have been removed according to the present invention to an ion exchange membrane electrolysis apparatus, chlorine and caustic soda can be stably produced without reducing electrolytic efficiency or the durability and the like of the electrode and ion exchange membrane.

### BRIEF DESCRIPTION OF DRAWINGS

FIG. 1a and FIG. 1b are system diagrams illustrating an example of an embodiment of a method for removing silica in the salt water of the present invention.

### DESCRIPTION OF EMBODIMENTS

Embodiments of the present invention are now described in detail.

In the present invention, after adjusting to a pH of 9 or more, salt water containing silica ions is brought into contact with a selective adsorbent for silica ions to selectively adsorb and remove the silica ions in the salt water with the adsorbent. Although there is no particular limitation on the method of contacting the salt water with the adsorbent, a method wherein the salt water is passed through an adsorption tower (adsorption column) filled with a selective adsorbent for silica ions is efficient.

Examples of the salt water containing silica ions to be treated in the present invention include seawater and a solution in which natural salts such as rock salt is dissolved. Usually, the content of salt (NaCl) in the salt water to be treated is about 25.4 to 26.4% by weight, the silica ion content is about 1 to 10 mg/L, and the pH is about 5.8 to 8.2.

If the pH of the salt water to be brought into contact with the selective adsorbent for silica ions is less than 9, the silica tends to be in a non-ionized form, and the adsorption removal efficiency of the silica ions is poor. Therefore, when the pH of the salt water is less than 9, an alkali such as sodium hydroxide is added to adjust the pH to 9 or more, for example, to about 9.5 to 11.

When a suspension of SS or the like is present in the salt water to be treated, it is preferable to remove the suspension in advance with a filter or the like because such a suspension may clog the adsorption tower.

The selective adsorbent for silica ions is not particularly limited as long as it is capable of selectively adsorbing silica ions without adsorbing the salt in the salt water. Examples of the selective adsorbent for silica ions include metal hydroxide adsorbents and strongly basic anion exchangers having a glucamine group. More specifically, a granulated body carrying a hydrous hydroxide of a rare earth metal such as cerium, a strongly basic styrenic anion exchange resin in which an N-methylglucamine group has been introduced, a fibrous adsorbent in which an N-methylglucamine group has been introduced, and the like can be used.

The granulated body carrying a hydrous hydroxide of a rare earth metal is a mixed granulated body of a hydrous hydroxide of a rare earth metal and an inorganic binder and the like, or is a granulated body obtained by dispersing a hydrous hydroxide of a rare earth metal in an organic polymer resin solution and then granulating while distilling off the solvent. Examples of the organic polymer resin include polyvinylidene fluoride resin, polytetrafluoroethylene resin, polyvinyl resin or natural polymers such as alginate, and derivatives thereof. Examples of the hydrous hydroxide of a rare earth metal include at least one or more kinds of hydrous hydroxide selected from cerium, lanthanum, neodymium, and yttrium. Examples of the inorganic binder include one kind or two or more kinds of an alumina sol, a titania sol, a zirconia sol, a zirconium ammonium carbonate, a silica sol, water glass, and a silica alumina sol. The content of the component derived from the inorganic binder in the adsorbent is preferably about 0.5 to 40% by weight in terms of oxide.

Such adsorbent can be produced by mixing a solution of the inorganic binder with a powder of the hydrous hydroxide of a rare earth metal, granulating the resultant mixture, and then drying or calcining in the range of 50 to 400° C.

One kind of selective adsorbent for silica ions may be used, or two or more kinds may be used by mixing together or by stacking and filling together.

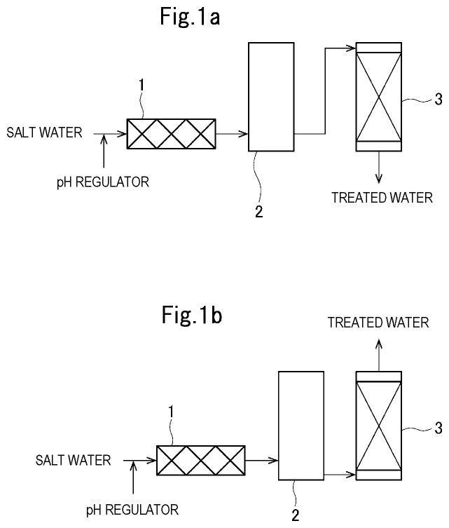

FIG. 1a and FIG. 1b are system diagrams illustrating an example of an embodiment of the method for removing silica in salt water of the present invention, in which salt water is treated by being passed through an adsorption tower filled with a selective adsorbent for silica ions. A pH regulator such as sodium carbonate or sodium hydroxide is added to the salt water to be treated, mixed by a line mixer 1, and suspensions in the salt water are filtered by a suspension filter 2. Then, water is flowed through an adsorption tower (or column) 3 filled with a selective adsorbent for silica ions to adsorb and remove silica ions in the salt water. The water flow may be, as illustrated in FIG. 1a, a downward flow system in which the salt water is supplied from an upper part of the adsorption tower (or column) 3 and the treated water is obtained from a lower part of the adsorption tower (column) 3. The water flow may also be, as illustrated in FIG. 1b, an upward flow system in which the salt water is supplied from the lower part of the adsorption tower (or column) 3 and the treated water is obtained from the upper part of the adsorption tower (column) 3.

The water flow rate of the salt water to the adsorption tower (or column) 3 is preferably in the range of 0.5 to 20 m/h. For an upward flow system, a flow rate (LV) of about 0.5 to 10 m/h is preferable so that the adsorbent does not move in a reverse direction against the flow. For a downward flow system, reverse movement against the flow of the adsorbent is less likely to occur because the flow restrains the adsorbent. On the other hand, if the flow rate is too fast, the flow may dig into the adsorbent layer, and thus the flow rate is preferably about 0.5 to 15 m/h.

If an anion, such as phosphoric acid, fluorine, boron, arsenic, or selenium, coexists in the salt water to be treated in an amount of, for example, 1/20 (mg/L concentration ratio) or more that of the silica ions, and in particular 1/10 (mg/L concentration ratio) or more, it is desirable to increase the adsorbent required for removing these anions or to separately remove these anions in advance.

However, since the degree of influence on silica ion adsorption depends on the anion species, and it is difficult to grasp the influence of all anion species, in actual practice, it is preferable to select an ion species having a large influence (e.g., boric acid, phosphoric acid), and to carry out a removal operation until the total amount (concentration) of those anions is less than 1/10 of the silica ions, particularly less than 1/20 of the silica ions.

The total amount (mg/L) of the above-selected undesirable coexisting anions and the increased amount of adsorbent react one to one with each other, and therefore it can be assumed that the amount of silica ions present is equal to the total amount of coexisting anions, and the adsorbent may be increased by an amount corresponding to the silica ions.

When the adsorbent has become break-through as a result of the treatment of the salt water, the adsorbent is regenerated and reused. For example, in an anion exchange resin generally used for anion adsorption, regeneration is carried out using only an alkali (NaOH), but in the present invention, it is preferable to first wash out the anion with an alkali (NaOH), then desorb the silica using an acid (HCl), and finally regenerate the adsorbent by once again flowing an alkali (NaOH) to adjust the adsorbent to be alkaline.

According to the present invention, caustic soda and chlorine can be stably and efficiently produced by ion exchange membrane electrolysis using salt water from which silica ions have been removed. There is no particular limitation on the specific operation of the ion exchange membrane electrolysis, which may be carried out in accordance with an ordinary method.

### EXAMPLES

The present invention will now be more specifically described by way of the following examples.

### Example 1

Raw water was prepared by adjusting salt water having a sodium chloride concentration of 26% by weight and a silica ion concentration of 3 mg/L in which natural rock salt was dissolved to a pH of 10.5 with sodium carbonate. This raw water was flowed in an upward flow at a linear flow rate (LV) of 0.5 m/h at room temperature (20° C.) in a column filled with 20 mL of a commercially available hydrous cerium hydroxide adsorbent “READ-B” (registered trademark of Nihonkaisui Co., Ltd.) as an adsorbent containing a metal hydroxide.

The hydrous cerium hydroxide adsorbent “READ-B” is a product prepared by dispersing hydrous cerium hydroxide powder in a solution of a copolymer resin of vinylidene fluoride and propylene hexafluoride and then granulating while distilling off the solvent. The amount of cerium hydroxide in the adsorbent is equivalent to 400 parts by weight of cerium hydroxide per 100 parts by weight of resin.

The silica ion concentration of the obtained treated water was measured by inductively-coupled plasma emission spectrometry. Further, the chlorine ion concentration of the obtained treated water was measured by a silver nitrate titration method, and converted into a salt (sodium chloride) concentration.

As a result, the sodium chloride concentration in the treated water was 26% by weight, the silica ion concentration was less than 0.2 mg/L, and it was confirmed that the silica ions had been adsorbed and removed by an ion exchange action without the sodium chloride in the salt water being adsorbed and removed.

### Example 2

The same raw water as in Example 1 was flowed in an upward flow at a linear flow rate (LV) of 0.5 m/h at room temperature (20° C.) in a column filled with 5 mL of an anion exchanger having a glucamine group (chelate resin “Diaion (registered trademark) CRB05” manufactured by Mitsubishi Chemical Corporation). The silica ion concentration and the salt concentration of the obtained treated water were determined in the same manner as in Example 1. The sodium chloride concentration in the treated water was 26% by weight, the silica ion concentration was 0.8 mg/L, and it was confirmed that the silica ions had been adsorbed and removed by an ion exchange action without the sodium chloride in the salt water being adsorbed and removed.

### Example 3

The same raw water as in Example 1 was flowed in a downward flow at a linear flow rate (LV) of 0.5 m/h at room temperature (20° C.) in a column filled with 20 mL of the same hydroxide-containing adsorbent “READ-B” as in Example 1. The silica ion concentration and the salt concentration of the obtained treated water were determined in the same manner as in Example 1. The sodium chloride concentration in the treated water was 26% by weight, the silica ion concentration was less than 0.2 mg/L, and it was confirmed that the silica ions had been adsorbed and removed by an ion exchange action without the sodium chloride in the salt water being adsorbed and removed.

### Example 4

The same raw water as in Example 1 was flowed in a downward flow at a linear flow rate (LV) of 0.5 m/h at room temperature (20° C.) in a column filled with 5 mL of an anion exchanger having a glucamine group (chelate resin “Diaion (registered trademark) CRB05” manufactured by Mitsubishi Chemical Corporation). The silica ion concentration and the salt concentration of the obtained treated water were determined in the same manner as in Example 1. The sodium chloride concentration in the treated water was 26% by weight, the silica ion concentration was 0.8 mg/L, and it was confirmed that the silica ions had been adsorbed and removed by an ion exchange action without the sodium chloride in the salt water being adsorbed and removed.

### Comparative Example 1

The same raw water as in Example 1 was filtered at high pressure using a seawater desalination reverse osmosis (RO) membrane. The silica ion concentration and the salt concentration of the obtained filtered water (permeated water) were determined in the same manner as in Example 1. The sodium chloride concentration in the treated water was 0.3% by weight, the silica ion concentration was less than 0.2 mg/L, and it was confirmed that the sodium chloride had also been removed together with the silica ions in the salt water by the RO membrane.

Although the present invention has been described in detail with reference to specific aspects, it will be apparent to those skilled in the art that various modifications are possible without departing from the spirit and scope of the invention.

The present application is based on Japanese Patent Application 2017-033457 filed on Feb. 24, 2017, which is hereby incorporated by reference in its entirety.

### REFERENCE SIGNS LIST

1 Line mixer
2 Suspension filter
3 Adsorption tower (or column)

1. A method for removing silica in salt water, comprising adjusting salt water containing silica ions to a pH of 9 or more, and then bringing the salt water into contact with a selective adsorbent for silica ions.

2. The method for removing silica in salt water according to claim 1, wherein the selective adsorbent for silica ions is a metal hydroxide adsorbent or a strongly basic anion exchanger having a glucamine group.

3. The method for removing silica in salt water according to claim 1, wherein the salt water containing silica ions is passed through an adsorption tower filled with the selective adsorbent for silica ions.

4. The method for removing silica in salt water according to claim 1, wherein the salt water containing silica ions is passed through the adsorption tower at a linear flow rate (LV) of 0.5 to 20 m/h.

5. A method for producing caustic soda and chlorine, comprising removing silica ion in salt water by the method for removing silica in salt water according to claim 1, and then producing caustic soda and chlorine by ion exchange membrane electrolysis.
